(19) United States
(12) Patent Application Publication
(10) Pub. No.: US 2009/0213315 A1
(43) Pub. Date: Aug. 27, 2009

(54) Liquid crystal on silicon display panel and electronic device using the same

(75) Inventor: Yi-Hua Wang, Tainan County (TW)

Correspondence Address: RABIN & Berdo, PC, 1101 14TH STREET, NW, SUITE 500, WASHINGTON, DC, 20005, US

(73) Assignee: Himax Display, Inc., Tainan County (TW)

(21) Appl. No.: 12/071,484

(22) Filed: Feb. 21, 2008

(51) Int. Cl. G02F 1/1337

(52) U.S. Cl. 349/123; 349/158; 349/122; 349/139

(57) ABSTRACT

A liquid crystal on silicon (LCOS) display panel and an electronic device using the same are provided. The LCOS display panel includes a silicon substrate, a transparent substrate, a color filter layer, an over-coating layer, an alignment layer, and a liquid crystal layer. The transparent substrate is opposite the silicon substrate. The color filter layer is on the silicon substrate and between the silicon substrate and the transparent substrate. The over-coating layer is on the color filter layer, and the alignment layer is on the over-coating layer. The liquid crystal layer is between the alignment layer and the transparent substrate.

### BACKGROUND OF THE INVENTION

1. Field of the Invention

The invention relates in general to a liquid crystal on silicon (LCOS) display panel and an electronic device using the same, and more particularly to a LCOS display panel capable of displaying colorful images and an electronic device using the same.

2. Description of the Related Art

As technology develops, electronic devices with display panels are widely applied in many fields. Important features that a customer would especially look for an electronic device including the color quality and the resolution of the display panel. Among different types of display panels, a liquid crystal on silicon (LCOS) display panel has good resolution and therefore is commonly used in many kinds of electronic devices.

In order to display colorful images, an LCOS display panel usually includes a color filter layer disposed under an alignment layer on the side of a silicon substrate. The color filter layer is between the alignment layer and the silicon substrate and includes color segments in different colors for displaying all kinds of colors. Because different color segments are sequentially formed on the substrates, the protrusions are usually formed at the conjunction of any two adjacent color segments; therefore, it is hard to control the flatness of the all color segments in the manufacturing process. As a result, the flatness of the surface of the color filter layer is poor, which usually results in uneven thickness of the alignment layer. When the color filter layer is too thick, the alignment layer is so thin, that the color filter layer is easily damaged in the rubbing process. The property of the alignment layer is affected, and the quality of displayed images is lowered. Accordingly, the yield rate of the manufacturing process of the LCOS display panel is reduced greatly.

### SUMMARY OF THE INVENTION

The invention is directed to a liquid crystal on silicon (LCOS) display panel and an electronic device using the same. An over-coating layer is between a color filter layer and an alignment layer for improving the display quality of the LCOS display panel.

According to the present invention, an LCOS display panel is provided. The LCOS display panel comprises a silicon substrate, a transparent substrate, a color filter layer, an over-coating layer, an alignment layer and a liquid crystal layer. The transparent substrate is opposite the silicon substrate. The color filter layer is on the silicon substrate and between the silicon substrate and the transparent substrate. The over-coating layer is on the color filter layer, and the alignment layer is on the over-coating layer. The liquid crystal layer is between the alignment layer and the transparent substrate.

According to the present invention, an electronic device including an LCOS display panel and a light source module is provided. The LCOS display panel comprises a silicon substrate, a transparent substrate, a color filter layer, an over-coating layer, an alignment layer and a liquid crystal layer. The transparent substrate is opposite the silicon substrate. The color filter layer is on the silicon substrate and between the silicon substrate and the transparent substrate. The over-coating layer is on the color filter layer, and the alignment layer is on the over-coating layer. The liquid crystal layer is between the alignment layer and the transparent substrate. The light source module is for providing the LCOS display panel with light.

The invention will become apparent from the following detailed description of the preferred but non-limiting embodiments. The following description is made with reference to the accompanying drawings.

### BRIEF DESCRIPTION OF THE DRAWINGS

FIG. 1 illustrates a liquid crystal on silicon (LCOS) display panel of an electronic device according to a preferred embodiment of the present invention;

FIGS. 2A-2E shows the forming steps of part of the LCOS display panel from a color filter layer to a first alignment layer in FIG. 1; and

FIG. 3 is a partial enlarged view of the LCOS display panel from the first alignment layer to the color filter layer in FIG. 1.

### DETAILED DESCRIPTION OF THE INVENTION

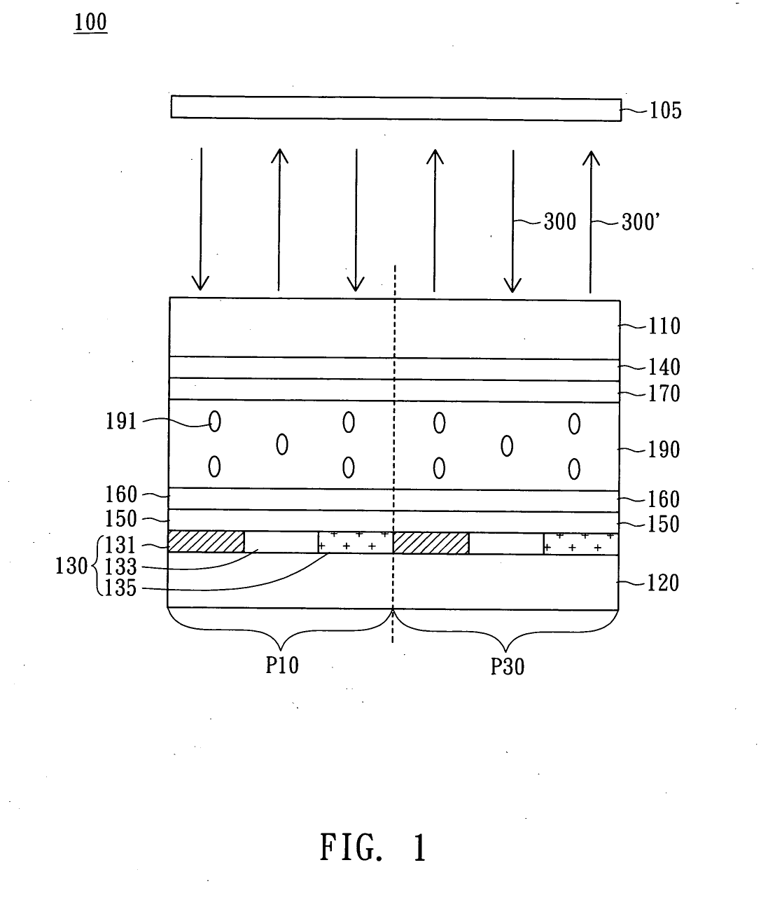

Please referring to FIG. 1, a liquid crystal on silicon (LCOS) display panel of an electronic device according to a preferred embodiment of the present invention is illustrated in FIG. 1. The electronic device includes an LCOS display panel 100 and a light source module 105. The LCOS display panel 100 comprises a transparent substrate 110, a silicon substrate 120, a color filter layer 130, an over-coating layer 150, a first alignment layer 160 and a liquid crystal layer 190. The transparent substrate 110 is opposite the silicon substrate 120. The color filter layer 130 is on the silicon substrate 120 and between the transparent substrate 110 and the silicon substrate 120. The over-coating layer 150 is on the color filter layer 130, and the first alignment layer 160 is on the over-coating layer 150. The liquid crystal layer 190 is between the first alignment layer 160 and the transparent substrate 110. The light source module 105 is for providing the LCOS display panel 100 with light 300′. By disposing the over-coating layer 150 on the color filter layer 130 in the LCOS display panel 100, the color filter layer 130 is protected from being damaged.

The LCOS display panel 100 further comprises a transparent electrode 140 and a second alignment layer 170. The transparent electrode 140 is on the transparent substrate 110 and between the transparent substrate 110 and the silicon substrate 120. The second alignment layer 170 is on the transparent electrode 140 and between the transparent electrode 140 and the liquid crystal layer 190. The silicon substrate 120 includes several pixel units, such as the pixel units P10 and P30. The color filter layer 130 includes several color segments respectively corresponding to the pixel units P10 and P30. In the present embodiment, each color segment includes three color regions, such as a red color region 131, a green color region 133 and a blue color region 135.

The light 300′ generated by the light source module 105 sequentially passes through the transparent substrate 110, the transparent electrode 140, the second alignment layer 170, the liquid crystal layer 190, the first alignment layer 160, the over-coating layer 150 and the color filter layer 130. Then, the light 300′ is incident to the silicon substrate 120 and forms reflected light 300. The reflected light 300 propagates away from the LCOS display panel 100 along the direction opposite to the light 300′, for displaying colorful images.

The liquid crystal layer 190 includes several liquid crystal molecules 191. An electric field is generated between the transparent electrode 140 and the silicon substrate 120 to control the rotation angles of the liquid crystal molecules 191. As a result, the intensity of the reflected light 300 is controlled. More specifically, the electric field between the pixel unit P10 and the transparent electrode 140 and the electric field between the pixel unit P30 and the transparent electrode 140 can be the same or different. The liquid crystal molecules 191 corresponding to the pixel units P10 and P30 rotate according to the corresponding electric fields. After the light 300′ is reflected by the silicon substrate 120, the light path in the liquid crystal layer 190 changes according to the rotation of the liquid crystal molecules 191. As a result, the LCOS display panel 100 displays images accordingly. When the electric field is generated between the silicon substrate 120 and the transparent electrode 140, the over-coating layer 150 prevents charged particles from entering the color filter layer 130, so that the color filter layer 130 is not damaged.

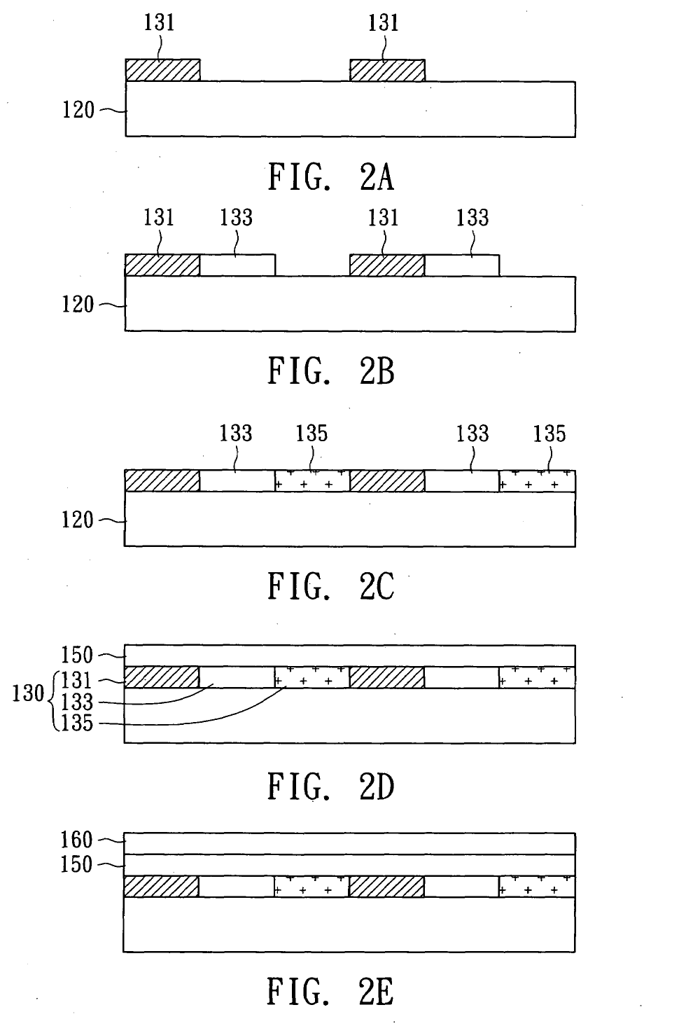

Please referring to FIGS. 2A-2E, the forming steps of part of the LCOS display panel from the color filter layer to the first alignment layer in FIG. 1 are illustrated in FIGS. 2A-2E.

In FIG. 2A, the red color region 131 is first formed on the silicon substrate 120. For example, the red color region 131 is formed by coating a red transparent material on the silicon substrate 120, and then the red transparent material is exposure and development. Next, as shown in FIG. 2B, the green color region 133 is formed on the silicon substrate 120 adjacent to the red color region 131. For example, the green color region 133 is defined by exposure and development a green transparent material. Similarly, as shown in FIG. 2C, the blue color region 135 is formed on the silicon substrate 120 adjacent to the green color region 133.

The color filter layer 130 includes the red color region 131, the green color region 133 and the blue color region 135. Because the red color region 131, the green color region 133 and the blue color region 135 are sequentially formed on the silicon substrate 120, the flatness of the color filter layer 130 is poor. In FIG. 2D, the over-coating layer 150 is formed on the color filter layer 130 for improving the flatness of the top surface.

As shown in FIG. 1, the light 300′ must pass through the over-coating layer 150. The over-coating layer 150 needs to be made of a transparent material. For example, the over-coating layer 150 is made of uncolored photoresist or transparent organic. Preferably, the over-coating layer 150 is made of negative photoresist, so that the over-coating layer 150 does not cracking after irradiated for a long time. When the thickness of the over-coating layer 150 is substantially 1000 angstrom (Å), the LCOS display panel 100 has better display quality.

Then, as shown in FIG. 2E, the first alignment layer 160 is formed on the over-coating layer 150. By disposing the over-coating layer 150 on the color filter layer 130, a better flatness of the top surface is improved. Therefore, the uniformity of the thickness of the first alignment layer 160 is increased.

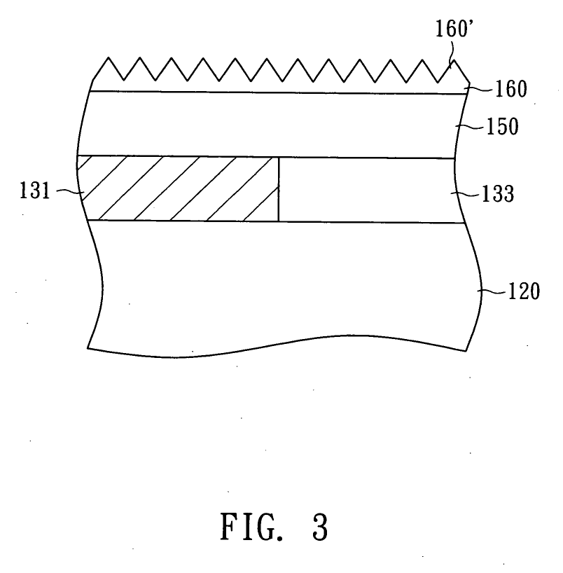

Please refer to FIG. 3. FIG. 3 is a partial enlarged view of the LCOS display panel from the first alignment layer to the color filter layer in FIG. 1. The first alignment layer 160 and the second alignment layer 170 (shown in FIG. 1) are made of polyimide (PI). First, a thin film of polyimide photoresist is formed on the over-coating layer 150. Then, a rubbing process is performed with a rubbing roller (now shown in drawings) on the first alignment layer 160. As a result, the first alignment layer 160 has several taper angles 160′. The over-coating layer 150 is able to protect the color filter layer 130, so that the color filter layer 130 is not damaged in the rubbing process. For example, when the red color region 131 overlaps the green color region 133, the overlapping part is thicker. The over-coating layer 150 protects the color filter layer 130 from being directly contacted by the rubbing roller in the overlapping part. Therefore, the taper angles 160′ are formed evenly, so that the liquid crystal molecules 191 are arranged uniformly according to the rubbing direction of the first alignment layer 160. Better quality of the taper angles 160′ of the first alignment layer 160 can be achieved through the over-coating layer 150.

Although the silicon substrate 120 includes two pixels P10 and P30 as an example in the LCOS display penal according to the preferred embodiment of the present invention, the present invention is not limited thereto. Anyone who has ordinary skill in the field of the present invention can understand that the number of the pixels of the silicon substrate and the number of the colors corresponding to each pixel can be varied. As long as the color filter layer, the over-coating layer and the alignment layer are sequentially formed on the silicon substrate, the present invention encompasses such modification.

In the LCOS display panel according to the above embodiment of the present invention, the over-coating layer is formed on the color filter layer when the color filter layer is on the side of the silicon substrate. As a result, the alignment layer on the side of the silicon substrate has better flatness, so that the taper angles of the alignment layer are formed uniformly. The over-coating layer also protects the color filter layer from being damaged in the rubbing process. Furthermore, when the LCOS display panel functions, the over-coating layer prevents the color filter layer from being damaged by charged particles. Therefore, the LCOS display panel of the embodiment of the present invention is able to display colorful images with better quality.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A liquid crystal on silicon (LCOS) display panel, comprising:
a silicon substrate;
a transparent substrate opposite the silicon substrate;
a color filter layer on the silicon substrate and between the silicon substrate and the transparent substrate;
an over-coating layer on the color filter layer;
a first alignment layer on the over-coating layer; and
a liquid crystal layer between the first alignment layer and the transparent substrate.

2. The LCOS display panel according to claim 1, wherein the over-coating layer is made of a transparent material.

3. The LCOS display panel according to claim 1, wherein the over-coating layer is made of a photoresist material.

4. The LCOS display panel according to claim 3, wherein the over-coating layer is made of a negative-photoresist material.

5. The LCOS display panel according to claim 1, further comprising:
a transparent electrode, disposed on the transparent substrate and between the silicon substrate and the transparent substrate.

6. The LCOS display panel according to claim 5, further comprising:
a second alignment layer, disposed on the transparent electrode and between the transparent electrode and the liquid crystal layer.

7. The LCOS display panel according to claim 6, wherein the first alignment layer and the second alignment layer are made of polyimide (PI).

8. The LCOS display panel according to claim 1, wherein the silicon substrate comprises a plurality of pixel units, the color filter layer comprises a plurality of color segments, and each of the color segments corresponds to one of the pixel units.

9. An electronic device, comprising:
a LCOS display panel, comprising:
a silicon substrate;
a transparent substrate opposite the silicon substrate;
a color filter layer on the silicon substrate and between the silicon substrate and the transparent substrate;
an over-coating layer on the color filter layer;
a first alignment layer on the over-coating layer; and
a liquid crystal layer between the first alignment layer and the transparent substrate; and
a light source module, for providing the LCOS display panel with light.

10. The electronic device according to claim 9, wherein the over-coating layer is made of a transparent material.

11. The electronic device according to claim 9, wherein the over-coating layer is made of a photoresist material.

12. The electronic device according to claim 11, wherein the over-coating layer is made of a negative-photoresist material.

13. The electronic device according to claim 9, wherein the LCOS display panel further comprises a transparent electrode, which is disposed on the transparent substrate and between the silicon substrate and the transparent substrate.

14. The electronic device according to claim 13, wherein the LCOS display panel further comprises a second alignment layer, which is disposed on the transparent electrode and between the transparent electrode and the liquid crystal layer.

15. The electronic device according to claim 14, wherein the first alignment layer and the second alignment layer are made of polyimide (PI).

16. The electronic device according to claim 9, wherein the silicon substrate comprises a plurality of pixel units, the color filter layer comprises a plurality of color segments, and each of the color segments corresponds to one of the pixel units.
